(19) United States
(12) Patent Application Publication
(10) Pub. No.: US 2014/0201092 A1
(43) Pub. Date: Jul. 17, 2014

(54) INTELLECTUAL-PROPERTY ASSEMBLY LINE

(71) Applicant: DEE VOLIN, FAIRVIEW, OR (US)

(72) Inventor: DEE VOLIN, FAIRVIEW, OR (US)

(21) Appl. No.: 14/157,457

(22) Filed: Jan. 16, 2014

Related U.S. Application Data
(60) Provisional application No. 61/753,699, filed on Jan. 17, 2013.

(51) Int. Cl. G06Q 50/18; G06Q 10/10

(52) U.S. Cl. CPC G06Q 50/184; G06Q 10/10
USPC 705/310

(57) ABSTRACT

A unique system comprises twenty describing formulas, at least one mobile or stationary device, and at least one operation or applicational software downloaded to the at least one mobile or stationary device for operating the at least one mobile or stationary device. Each of the twenty describing formulas is for describing only one aspect of an invention, at the simplest descriptive level. The unique system is for helping a user be able to quickly and easily describe, preserve, and benefit from an invention.

### REFERENCE TO PREVIOUSLY FILED PROVISIONAL PATENT APPLICATION

Provisional Patent Application No. 61/753,699 was filed on Jan. 17, 2013.

### BACKGROUND OF THE INVENTION

1) Field of the Invention

The present invention relates to a unique system for helping a user be able to quickly and easily describe, preserve, and benefit from an invention. Particularly, the present invention relates to a unique system, which comprises descriptive formulas, device, and software. Each of the descriptive formulas is for describing only one aspect of an invention, at the simplest descriptive level.

2) Description of the Prior Art

A number of describing methods have been introduced. U.S. Pat. No. 3,794,813, filed Jul. 28, 1972, to Spetz, William L.; U.S. Pat. No. 4,184,148, filed Jan. 25, 1977, to Smagala-Romanoff, Edward A.; U.S. Pat. No. 4,829,569, filed Jul. 8, 1986, to Seth-Smith, Nigel; U.S. Pat. No. 4,866,770, filed Aug. 14, 1986, to Seth-Smith, Nigel; U.S. Pat. No. 5,091,936, filed Jan. 30, 1991, to Katznelson, Ron D.; U.S. Pat. No. 5,359,601, filed Mar. 8, 1993, to Wasilewski, Anthony J.; U.S. Pat. No. 5,428,349, filed Oct. 1, 1992, to Baker, Daniel G.; U.S. Pat. No. 5,600,378, filed May 22, 1995, to Wasilewski, Anthony J.; U.S. Pat. No. 6,249,320, filed Dec. 22, 1998, to Schneidewend, Daniel Richard; U.S. Pat. No. 6,686,931, filed Aug. 20, 2001, to Bodnar, Eric O.; U.S. Pat. No. 6,792,466, filed Sep. 12, 2000, to Saulpaugh, Thomas E.; U.S. Pat. No. 7,536,556, filed Jul. 27, 2001, to Fedorova, Yulia Vladimirovna; U.S. Pat. No. 7,680,818, filed Dec. 18, 2002, to Fan, Zili; U.S. Pat. No. 7,844,825, filed Oct. 21, 2005, to Neginsky, Alex; U.S. Pat. No. 8,621,500, filed Dec. 2, 2011, to Weaver, Timothy H.; U.S. Pat. No. 8,621,578, filed Dec. 10, 2008, to Blomquist, Scott A.; U.S. Pat. No. 8,621,645, filed Aug. 23, 2012, to Spackman, Stephen Philip; and U.S. Pat. No. 8,621,650, filed Jan. 6, 2012, to Cakulev, Violeta disclose a variety of inventions related to complex and compiling methods of description.

The prior art has failed to solve many problems associated with such complex and compiling methods of description, as follows:

1) The prior-art complex and compiling methods of description describe many aspects of an invention in a complex paragraph.

No prior art offers or discloses a system of twenty describing formulas for describing the necessary aspects of an invention at the simplest descriptive level.

2) The prior-art complex and compiling methods of description do not organize many aspects of an invention in any order in a complex paragraph.

No prior art offers or discloses a system of twenty describing formulas for describing the necessary aspects of an invention at the simplest descriptive level.

3) The prior-art complex and compiling methods of description compile many aspects of an invention in a complex paragraph, which is hard to understand.

No prior art offers or discloses a system of twenty describing formulas for describing the necessary aspects of an invention at the simplest descriptive level.

4) The prior-art complex and compiling methods of description compile many aspects of an invention in a complex paragraph, which is hard to figure out and refer to all the aspects of each components of the invention.

No prior art offers or discloses a system of twenty describing formulas for describing the necessary aspects of an invention at the simplest descriptive level.

### OBJECTS AND ADVANTAGES OF THE INVENTION

As a result of all the 40 following important advantages, the unique system will advance the economy, significantly:

### Enhancing Inventors' Capability

1) The unique system provides people of almost any age with a substantially effective and efficient method to quickly, easily, and clearly describe, understand, and invent inventions substantially better, by breaking the description of an invention into twenty simple formulas. Each of the simple formulas is for describing only one aspect of the invention (at the simplest descriptive level). This allows people of almost any age to quickly, easily, and clearly understand all the aspects of the invention (individually and collectively).
2) The unique system allows people of almost any age to quickly, easily, and clearly describe, specify, and broaden the scope of their inventions substantially better, by using the twenty simple formulas to create twenty simple sections. Each of the twenty simple sections is for describing only one aspect of the invention (at the simplest descriptive level). The twenty simple sections are, as follows: title, figure, reference, component, material, shape, dimension, smell, taste, feel, sound, connection, function, operation, purpose, advantage, variation, ramification, how to draw an invention, and how to file an invention.
3) The unique system allows people of almost any age to enhance their inventive capability substantially, by allowing them to quickly, easily, and clearly describe, understand, and invent all the aspects of all the components of an invention (at the simplest descriptive level).
4) The unique system allows people of almost any age to enhance their inventive capability substantially, by allowing them to be able to compare new unobvious advantages their inventions provide to old obvious disadvantages prior-art inventions provide (at the simplest descriptive level).

### Elevating their Inventions' Patentability

5) The unique system allows people of almost any age to elevate the patentability of their inventions, by allowing them to quickly, easily, and clearly understanding how many necessary components an invention needs to comprise to be complete and functional (at the simplest descriptive level).
6) The unique system allows people of almost any age to elevate the patentability of their inventions, by allowing them to quickly, easily, and clearly understanding what material each component of an invention is made of (at the simplest descriptive level).
7) The unique system allows people of almost any age to elevate the patentability of their inventions, by allowing them to quickly, easily, and clearly understanding what shape each component of an invention has (at the simplest descriptive level).
8) The unique system allows people of almost any age to elevate the patentability of their inventions, by allowing them to quickly, easily, and clearly understanding what dimension, smell, taste, and feel each component of an invention has (at the simplest descriptive level).
9) The unique system allows people of almost any age to elevate the patentability of their inventions, by allowing them to quickly, easily, and clearly understanding what sound each component of an invention makes (at the simplest descriptive level).
10) The unique system allows people of almost any age to elevate the patentability of their inventions, by allowing them to quickly, easily, and clearly understanding how each component of an invention is connected to other components (at the simplest descriptive level).
11) The unique system allows people of almost any age to elevate the patentability of their inventions, by allowing them to quickly, easily, and clearly understanding how each component of an invention functions (at the simplest descriptive level).
12) The unique system allows people of almost any age to elevate the patentability of their inventions, by allowing them to quickly, easily, and clearly understanding how an invention operates, what purposes the invention serves, what advantages the invention provides, what variations the invention has, and what ramifications the invention has (at the simplest descriptive level).

### Preserving Inventors' Rights, Eliminating Financial Obstacles, and Saving them a Lot of Money

13) The unique system allows people of almost any age to quickly and easily learn the twenty simple formulas, to preserve their rights to potential patents with ‘patent pending’ status for their inventions, on their own. Each of the twenty simple formulas is for describing only one aspect of the invention (at the simplest descriptive level). For example, an inventor can learn how to use the twenty simple formulas, within an hour.
14) The unique system provides people of almost any age with the capability to describe as many inventions as they want and to preserve their rights to potential patents with ‘patent pending’ status for their inventions, on their own. This eliminates the high cost of patent legal services.
15) The unique system eliminates the devastating problem of invention theft, by providing people of almost any age with the capability to describe their inventions and to preserve their rights to potential patents with ‘patent pending’ status, on their own, in total confidentiality. For example, inventors don't have to disclose their valuable inventions to total strangers for help with describing their inventions.
16) The unique system eliminates the financial roadblock created by the high cost of patent legal services, and saves significant amounts of money for people (Inventors don't have to blindly waste money on patent legal services for inventions before they are proven in the marketplace), by providing people of almost any age with the capability to describe as many inventions as they want and to preserve their rights to potential patents with ‘patent pending’ status for their inventions, on their own.
17) The unique system eliminates the financial roadblock created by the high cost of invention-drawing services, and saves significant amounts of money for people (Inventors don't have to blindly waste money on invention-drawing services for inventions before they are proven in the marketplace), by providing people of almost any age with the capability to hand-draw and/or computer-draw as many inventions as they want, on their own.

### Maximizing the Inventive Capability of Brilliant Inventors

18) The unique system allows people to utilize their brilliant minds to their maximum capability, by eliminating the financial obstacle of the high cost of patent legal services. For example, because inventors don't need any money to pay for patent legal services, they can freely invent to come up with as many brilliant inventions as possible, and can preserve their rights to potential patents with ‘patent pending’ status, on their own.
19) The unique system allows all brilliant minds to:
   Freely invent as many brilliant inventions as they want, and
   Freely preserve their rights to potential patents with ‘patent pending’ status for as many brilliant inventions as they want.
20) The unique system allows each inventor to present, not one, but multiple ‘patent pending’ inventions, at the same time, to prospective companies. This will increase each inventor's success rate of selling and/or licensing his inventions to the prospective companies;
21) The unique system allows prospective companies to have, not one, but multiple ‘patent pending’ inventions to choose from, at the same time, from each inventor. This will increase the prospective companies' success rate of profiting from each inventor's inventions.

### Filtering Out Unwanted Inventions, and Increasing the Number of Wanted Inventions, Substantially

22) The unique system allows prospective companies to:
   Filter out all unwanted inventions presented by inventors because the prospective companies have direct contact with consumers so they know what consumers don't want,
   Sign contracts with inventors to buy the legal rights of only wanted inventions or to be licensed to produce and sell only wanted inventions presented by inventors because the prospective companies have direct contact with consumers so they know what consumers want,
   Save significant amounts of time and money from their own research and development, and
   On behalf of inventors, hire patent law firms to file non-provisional patent applications for only the wanted inventions with the USPTO.
23) The unique system allows inventors to present, not one, but multiple ‘patent pending’ inventions, at the same time, to prospective companies. This allows the inventors to:
   Know which inventions are unwanted to avoid investing their inventive capability in them,
   Know which inventions are wanted to invest their inventive capability in them and, thus, save significant amounts of time and money from their own research and development,
   Focus their inventive capability on inventing only wanted inventions, and thus
   Increase the number of wanted inventions they will come up with, substantially.

### Preventing Unwanted Inventions from being Filed with the Patent and Trademark Office

24) The unique system eliminates and prevents all unwanted inventions from being filed with the USPTO because after all the unwanted inventions are filtered out, neither inventors nor prospective companies want to waste money for patent law firms to file non-provisional patent applications for the unwanted inventions with the USPTO. This eliminates all unnecessary workloads on the USPTO, and solves the long-felt problem of the USPTO having been overwhelmed with so many patent applications for unwanted inventions, which have wasted precious intellectual resources from inventors, companies, the USPTO, and, thus, the economy.

### Increasing Inventors' Revenues, Substantially, and Increasing Companies' Revenues, Substantially

25) The unique system allows inventors to avoid wasting their intellectual resources and their hard-earned money on unwanted inventions and the high cost of patent legal services.
26) The unique system, substantially, increases the number of brilliant inventions (invented by inventors and sold or licensed to companies to produce and sell to consumers, to advance the economy). Therefore, the unique system increases the number of contracts signed between inventors and companies, and, thus, inventors' and companies' revenues, substantially.
27) The unique system, substantially, increases the number of products (embodying brilliant inventions from inventors, produced by companies, and sold to consumers, to advance the economy). As a result of all the above 27 important advantages, the unique system will advance the economy.

### Increasing Patent Law Firms' Revenues, Substantially

28) The unique system increases patent law firms' revenues, substantially, by increasing the number of non-provisional patent applications (for only wanted inventions) to be filed with the USPTO, substantially, as follows:
   a) Each inventor unguidedly comes up with multiple unwanted inventions:
      Without the unique system, each inventor comes up with multiple inventions, and only has enough financial resource to hire a patent law firm to file a none-provisional patent application for one of his inventions. If this invention he presents to prospective companies is an unwanted invention (most of inventions are unwanted inventions because inventors don't have direct contact with consumers like prospective companies do so they don't know what consumers want), prospective companies will not want to invest in and lose money from it. The inventor doesn't want to waste any more of his hard-earned money and years of his life waiting, and thus, decides not to invent any more. As a result, the patent law firm gets only one order of filing a non-provisional patent application from the inventor.
   b) Each inventor guidedly comes up with multiple wanted inventions:
      With the unique system, each inventor can eliminate the high cost of patent law firm. Therefore, each inventor can freely invent to come up with multiple inventions and file provisional patent applications to get ‘patent pending’ status to preserve his rights to potential patents for all his inventions, on his own. Among each inventor's inventions presented, prospective companies will be able to pick out a wanted invention to invest in and profit from. The prospective companies will want each inventor to keep coming up with wanted inventions so they can save money on their own research and development. Knowing what wanted inventions are, each inventor starts focusing his inventive capability on coming up with only wanted inventions. Therefore, the number of wanted inventions each inventor will come up with will increase substantially, and each inventor will be able to sell and/or license, not one, but multiple wanted inventions to prospective companies. As a result, the patent law firm will keep getting, not one, but multiple orders of filing non-provisional patent applications from each inventor and/or prospective companies.
   Therefore, the unique system increases patent law firms' revenues, substantially,

### Learning and Referring to the Twenty Formulas, Quickly and Easily (Via Mobile Devices)

29) The unique system increases the convenience of mobile devices (e.g., smart phone, tablet, etc.) and eliminates the need for expensive cumbersome stationary devices (e.g., desktop computer, etc.) because the twenty formulas is invented to be large enough to be functionally legible within the dimension of the screen of mobile devices. This eliminates the inconvenient needs for people to enlarge and move the content of a file around, within the screen. Therefore, people of almost any age can learn and refer to the twenty formulas, quickly and easily, via mobile devices.
30) The unique system increases the practicality of mobile devices (e.g., smart phone, tablet, etc.) and eliminates the need for expensive cumbersome stationary devices (e.g., desktop computer, etc.) because the twenty formulas is invented to be large enough to be functionally legible within the dimension of the screen of mobile devices. This eliminates the inconvenient needs for people to enlarge and move the content of a file around, within the screen. Therefore, people of almost any age can learn and refer to the twenty formulas, quickly and easily, via mobile devices.
31) The unique system increases the usability of mobile devices (e.g., smart phone, tablet, etc.) and eliminates the need for expensive cumbersome stationary devices (e.g., desktop computer, etc.) because the twenty formulas is invented to be large enough to be functionally legible within the dimension of the screen of mobile devices. This eliminates the inconvenient needs for people to enlarge and move the content of a file around, within the screen. Therefore, people of almost any age can learn and refer to the twenty formulas, quickly and easily, via mobile devices.
32) The unique system increases the value of mobile devices (e.g., smart phone, tablet, etc.) and eliminates the need for expensive cumbersome stationary devices (e.g., desktop computer, etc.) because the twenty formulas is invented to be large enough to be functionally legible within the dimension of the screen of mobile devices. This eliminates the inconvenient needs for people to enlarge and move the content of a file around, within the screen. Therefore, people of almost any age can learn and refer to the twenty formulas, quickly and easily, via mobile devices.

### Learning and Referring to the Twenty Formulas (Via Mobile Devices, at any Time and Place), and Inventing and Describing Inventions (Via Mobile Devices, at any Time and Place)

33) The unique system allows people to learn and refer to the twenty formulas quickly and easily at any time and place (e.g., on a walk, in a park, on a beach, at a bus stop, in a meeting, etc.) via mobile devices (e.g., smart phone, tablet, etc.) because the twenty formulas is invented to be large enough to be functionally legible within the dimension of the screen of mobile devices. This eliminates the inconvenient needs for people to enlarge and move the content of a file around within the screen, constantly. Therefore, people of almost any age can learn and refer to the twenty formulas, quickly and easily, via mobile devices. This eliminates the need for expensive cumbersome stationary devices (e.g., desktop computer, etc.).
34) The unique system allows people to invent and record inventions, conveniently, at any time and place (e.g., on a walk, in a park, on a beach, at a bus stop, in a meeting, etc.) via mobile devices (e.g., smart phone, tablet, etc.) because the twenty formulas is invented to be large enough to be functionally legible within the dimension of the screen of mobile devices. This eliminates the inconvenient needs for people to enlarge and move the content of a file around within the screen, constantly. Therefore, people of almost any age can learn and refer to the twenty formulas, quickly and easily, via mobile devices. This eliminates the need for expensive cumbersome stationary devices (e.g., desktop computer, etc.).
35) The unique system allows people to describe inventions by using voice-to-text function, at any time and place (e.g., on a walk, in a park, on a beach, at a bus stop, in a meeting, etc.) via mobile devices (e.g., smart phone, tablet, etc.) because the twenty formulas is invented to be large enough to be functionally legible within the dimension of the screen of mobile devices. This eliminates the inconvenient needs for people to enlarge and move the content of a file around within the screen, constantly. Therefore, people of almost any age can learn and refer to the twenty formulas, quickly and easily, via mobile devices. This eliminates the need for expensive cumbersome stationary devices (e.g., desktop computer, etc.).

### Transmitting Inventions Between Mobile Devices, Stationary Devices, and the Internet

36) The unique system increases the convenience, practicality, usability, value of software used on mobile devices (e.g., smart phone, tablet, etc.), with the synergism of the twenty formulas, software, and mobile devices.
37) The unique system allows people to:
   Learn the twenty formulas
   (by using converting-voice-to-text function, converting-text-to-voice function, voice command, touch command, signal command, mechanical command, etc.), at any time and place, via software used on mobile devices
   (e.g., smart phone, tablet, etc.);
   Refer to the twenty formulas
   (by using converting-voice-to-text function, converting-text-to-voice function, voice command, touch command, signal command, mechanical command, etc.), at any time and place, via software used on mobile devices
   (e.g., smart phone, tablet, etc.);
   Invent and record inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Describe their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Draw their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Store their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Transmit their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Share their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Email their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Fill out patent applications for inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   File patent applications for inventions,
   (by using converting-voice-to-text function, converting-text-to-voice function, voice command, touch command, signal command, mechanical command, etc.), at any time and place, via software used on mobile devices
   (e.g., smart phone, tablet, etc.); and
   Pay filing fees for patent applications,
   (by using converting-voice-to-text function, converting-text-to-voice function, voice command, touch command, signal command, mechanical command, etc.), at any time and place, via software used on mobile devices
   (e.g., smart phone, tablet, etc.).
38) The unique system allows people to use all the possible functions of software used on mobile devices (for example, some functions are: converting voice to text, converting text to voice, activating by voice, activating by touch, wireless uploading, wireless downloading, wireless transmitting, etc.), to eliminate the needs for using cumbersome pen and paper, to:
   Learn the twenty formulas, at any time and place
   (e.g., on a walk, in a park, on a beach, at a bus stop, in a meeting, etc.);
   Invent and record their inventions, at any time and place
   (e.g., on a walk, in a park, on a beach, at a bus stop, in a meeting, etc.);
   Describe their inventions, at any time and place
   (e.g., on a walk, in a park, on a beach, at a bus stop, in a meeting, etc.); and
   Draw their inventions, at any time and place
   (e.g., on a walk, in a park, on a beach, at a bus stop, in a meeting, etc.).
39) The unique system allows people to conveniently transmit their inventions electronically:
   From mobile devices to mobile devices (e.g., smart phone, tablet, etc.) to share (for example, in a meeting, at a conference, etc.), at any time and place;
   From mobile devices to stationary devices (e.g., desktop computer, etc.) to store (for example, on Sugarsync for future use, etc.), at any time and place;
   From mobile devices to the internet (e.g., website of the USPTO, email account, etc.) to file provisional or non-provisional patent applications, at any time and place; and
   From stationary devices to the internet (e.g., website of the USPTO, etc.) to file provisional or non-provisional patent applications, at any time and place.

### Best Maximizing the Capability of Precious Intellectual Resources, Nationwide and Globally

40) The unique system allows people and/or prospective companies to, quickly and easily:
   Free themselves to invent as many inventions as they want, by eliminate the financial obstacle of the high cost of patent legal services, which has stifled their inventive capability.
   File provisional patent applications to preserve their rights with ‘patent pending’ status for all their inventions, on their own, in total confidentiality,
   Filter out all unwanted inventions,
   Focus on inventing only wanted inventions,
   Save significant amounts of time and money from their own research and development,
   Increase the number of wanted inventions invented, substantially,
   Increase the number of contracts signed between them, substantially,
   Increase the revenues of inventor and prospective companies, substantially,
   Place multiple orders with patent law firms to file non-provisional patent applications for only their wanted inventions. This increases the revenues of patent law firms, substantially,
   Describe their inventions, via mobile devices, at any place and time,
   Share their inventions, via mobile devices, at any place and time,
   Store their inventions, via mobile devices, at any place and time,
   File patent applications for inventions, via mobile devices, at any place and time, and
   Eliminate and prevent all unwanted inventions from being filed with the USPTO. This eliminates all unnecessary workloads on the USPTO, and solves the long-felt problems of the USPTO having been overwhelmed with so many patent applications for unwanted inventions, which have wasted precious intellectual resources from inventors, companies, patent law firms, the USPTO, and, thus, the economy.
   Therefore, the unique system best maximizes the capability of precious intellectual resources from inventors, companies, patent law firms, the USPTO, and, thus, the economy.

As a result of all the above forty important advantages, the unique system will advance the economy, significantly.

### BRIEF DESCRIPTION OF THE DRAWINGS

FIG. 1 illustrates the task menu, on a mobile device (e.g., smart phone, tablet, etc.).

FIG. 2 illustrates the command menu, on a mobile device (e.g., smart phone, tablet, etc.).

FIG. 3 illustrates the unique-system formulas, on a mobile device (e.g., smart phone, tablet, etc.).

FIG. 4 illustrates the material formula and its section, which describes only the materials, at the simplest descriptive level, on a mobile device (e.g., smart phone, tablet, etc.).

FIG. 5 illustrates the advantage formula and its section, which describes only the advantages, at the simplest descriptive level, on a mobile device (e.g., smart phone, tablet, etc.).

FIG. 6 illustrates a zoomed-in perspective view of the sample invention of footwear, displayed by a video-and-audio mobile application, on a mobile device (e.g., smart phone, tablet, etc.).

FIG. 7 illustrates a zoomed-in side view of the footwear, displayed by the video-and-audio mobile application, on a mobile device (e.g., smart phone, tablet, etc.).

FIG. 8 illustrates how the actual drawing sheet (8½″×11″) of the invention of footwear looks, displayed by the mobile application, on a mobile device (e.g., smart phone, tablet, etc.).

FIG. 9 illustrates the material section, which describes only the materials, at the simplest descriptive level, on a mobile device (e.g., smart phone, tablet, etc.).

FIG. 10 illustrates the advantage section, which describes only the advantages, at the simplest descriptive level, on a mobile device (e.g., smart phone, tablet, etc.).

FIG. 11 illustrates the variation section, which describes only the variations, at the simplest descriptive level, on a mobile device (e.g., smart phone, tablet, etc.).

### BRIEF SUMMARY OF THE INVENTION

A unique system comprises twenty describing formulas, at least one mobile or stationary device, and at least one operation or applicational software downloaded to the at least one mobile or stationary device for operating the at least one mobile or stationary device. Each of the twenty describing formulas is for describing only one aspect of an invention, at the simplest descriptive level. The unique system is for helping a user be able to quickly and easily describe, preserve, and benefit from an invention.

### DETAILED DESCRIPTION OF THE INVENTION

### Structure

A unique system comprises: a) twenty formulas (for example, electronic application such as e-book, book, etc.), b) at least one device (for example, mobile device or stationary device, such as smart phone, tablet, etc., which stores, displays, describes, fill outs, transmits the twenty formulas, inventions, form, etc.), and c) at least one software (for example, operating software, applicational software, etc., which perform all possible software functions for the twenty formulas and the at least one device).

Each of the twenty formulas is for describing only one aspect of an invention (at the simplest descriptive level). The twenty describing formulas are for describing the following twenty aspects of an invention, respectively: 1) Title, 2) Figure, 3) Reference, 4) Component, 5) Material, 6) Shape, 7) Dimension, 8) Smell, 9) Taste, 10) Feel, 11) Sound, 12) Connection, 13) Function, 14) Operation, 15) Purpose, 16) Advantage, 17) Variation, 18) Ramification, 19) How to draw an invention, and 20) How to file an invention.

The twenty formulas comprise:

1) Title Formula for describing only the title of an invention:

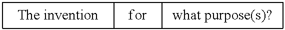

2) Figure Formula for briefly describing only the figure(s) of an invention:

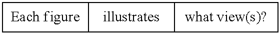

3) Reference Formula for describing only the component name(s) and reference number(s):

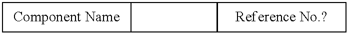

4) Component Formula for describing only what component(s) an invention comprises:

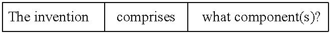

5) Material Formula for describing only what material(s) each component is made of:

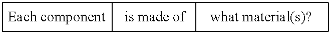

6) Shape Formula for describing only what shape(s) each component has:

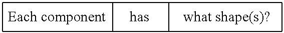

7) Dimension Formula for describing only what dimension(s) each component has:

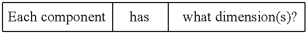

8) Smell Formula for describing only what smell(s) each component has:

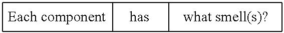

9) Taste Formula for describing only what taste(s) each component has:

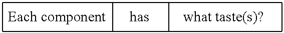

10) Feel Formula for describing only what feel(s) each component has:

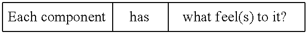

11) Sound Formula for describing only what sound(s) each component makes:

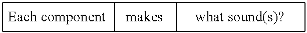

12) Connection Formula for describing only how each component is connected to other(s):

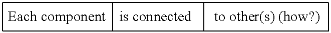

13) Function Formula for describing only what function(s) each component is for:

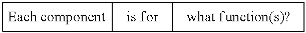

14) Operation Formula for describing only how an invention operates:

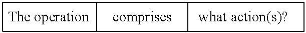

15) Purpose Formula for describing only what purpose(s) an invention serves:

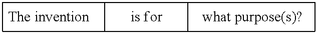

16) Advantage Formula for describing only what advantage(s) an invention provides:

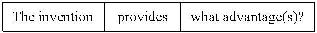

17) Variation Formula for describing only what variation(s) each component has:

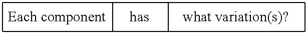

18) Ramification Formula for describing only what ramification(s) each component has:

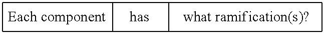

19) Invention-Drawing Formula for drawing an invention:
Following the guide line on the website of the USPTO (www.USPTO.gov), computer-draw an invention. Or hand-draw an invention (e.g., using a dark pencil, ball-point pen, gel pen, felt-tip pen, or an equivalent), and then photocopy the figures; and

20) Application-Filing Formula for filing a provisional patent application:
Following the guide line on the website of the patent office, for example, the USPTO (the United States patent and trademark office) (www.USPTO.gov), file a provisional patent application online on the website, using a required form and paying a required fee (for example, Form SB/16—EFS-Web. Fee $125 US).
Or:
   1) Fill out the required form online (for example, Form SB16). Print it out and sign it,
   2) Print out the description and drawings of an invention,
   3) Buy a money order of the USPS (U.S. postal services) for the filing fee.
   4) Mail all items above by using the service of EXPRESS MAIL TO ADDRESSEE, to the USPTO, for example, at: Mail stop: Provisional Patent Application, Commissioner for Patents P.O Box 1450, Alexandria, Va. 22313-1450

### Operation

To describe an invention, at least one of the twenty formulas of the unique system can be used. Each of the twenty formulas used is for describing only one aspect of the invention, at the simplest descriptive level.

### First Example

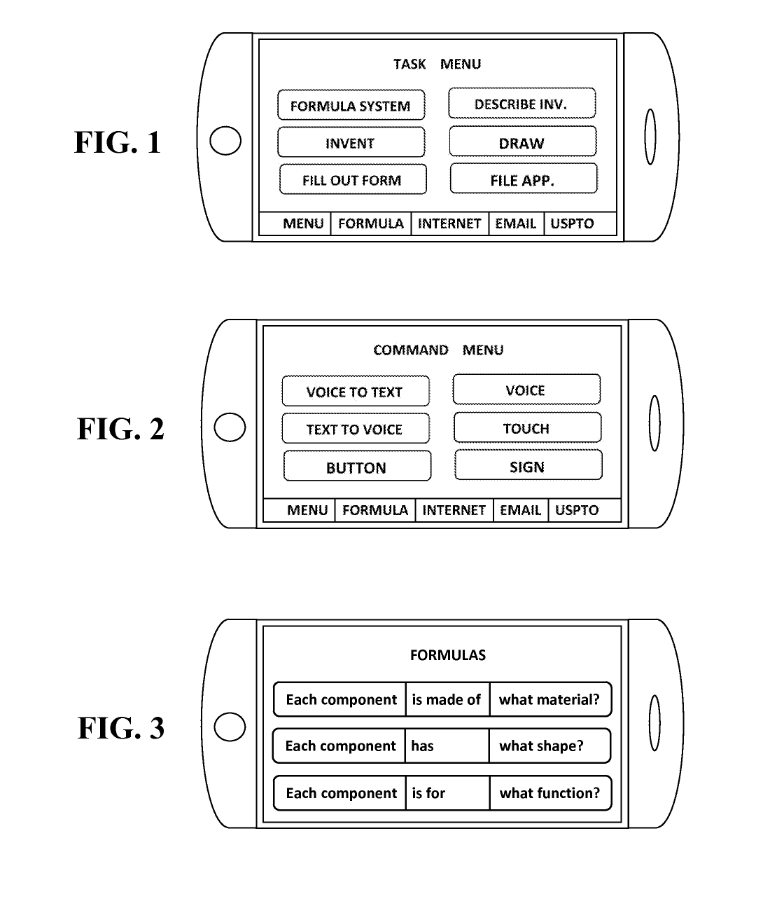

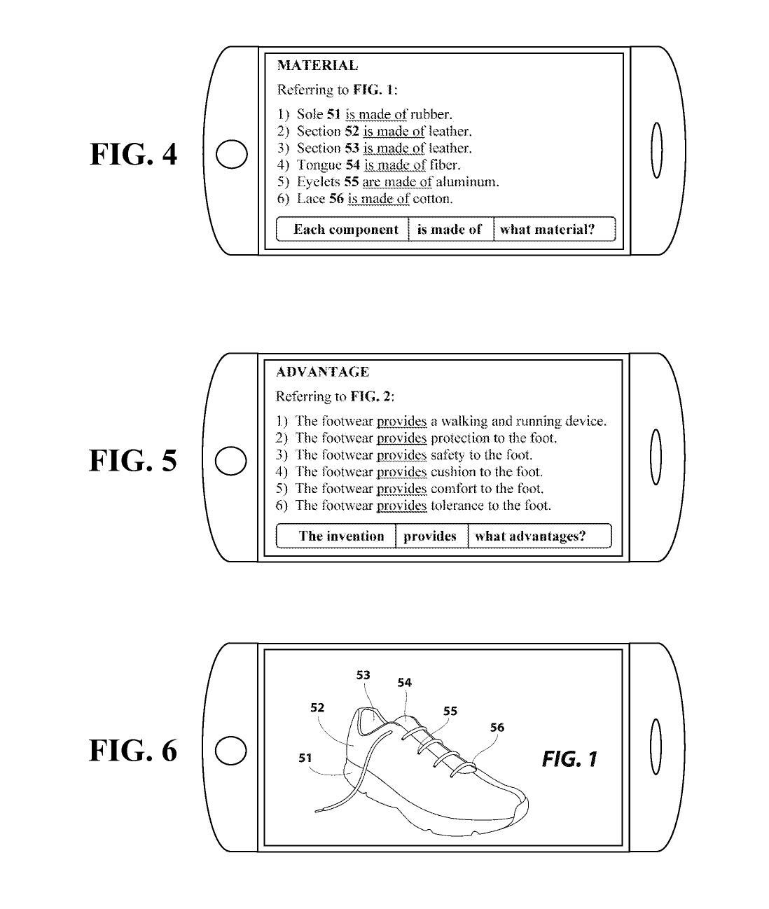

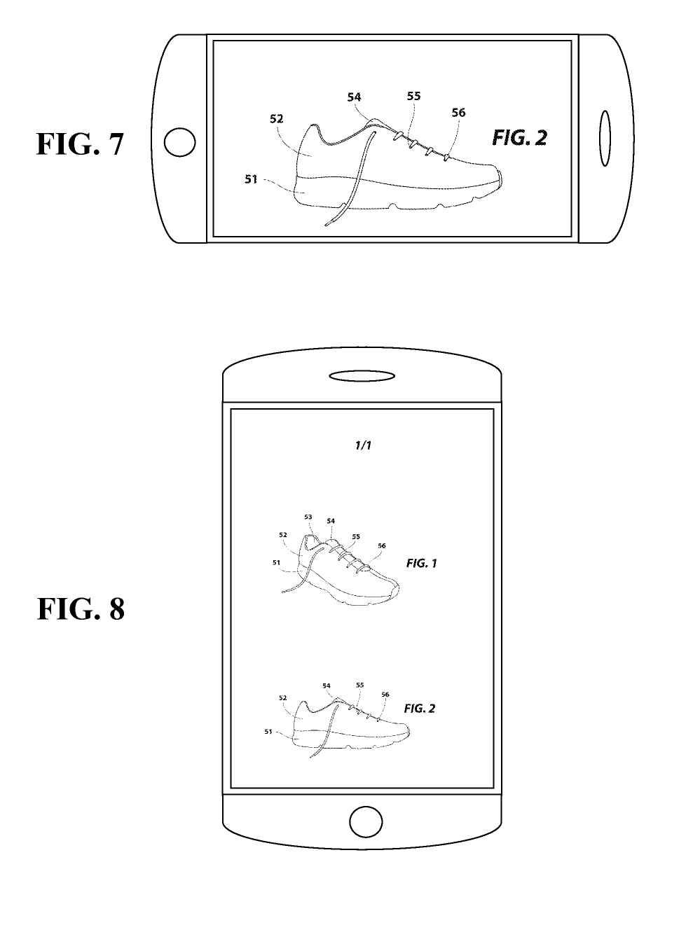

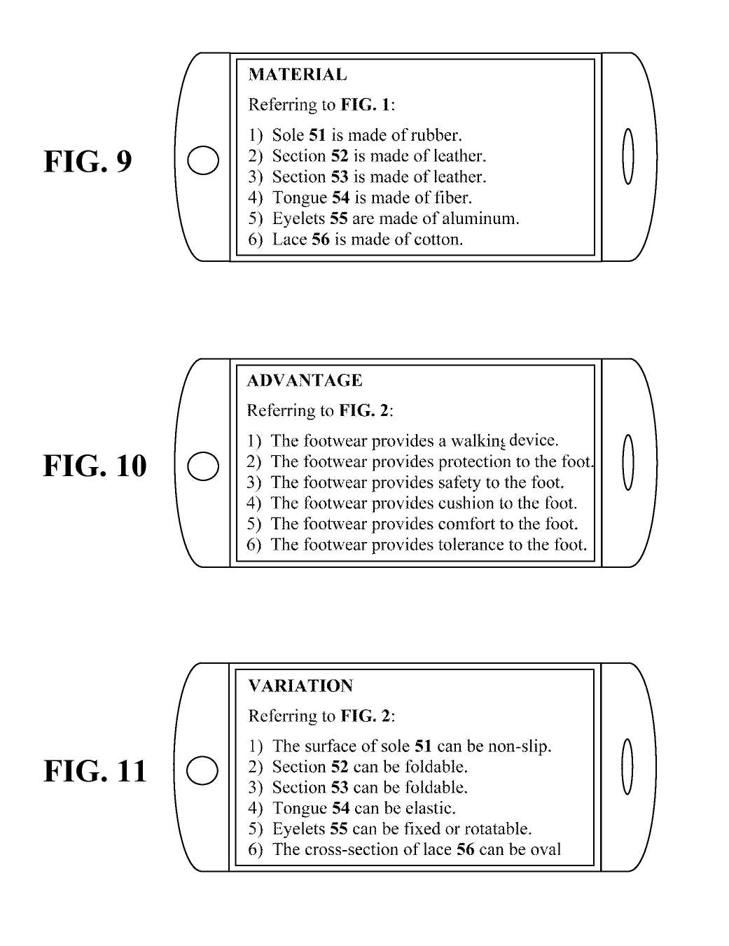

Referring to FIGS. 1, 2, 3, 4, 5, 6, 7, and 8, the twenty formulas can be created as a mobile application and/or can be displayed on or via a mobile device. The twenty-formula mobile application can be one of the following:
1) Video-and-audio or e-book application, having all possible software functions.
   For example, some of the functions an application can have are: sounding, zooming, panning, captioning, fading, sliding, rotating, scrolling, converting voice to text, converting text to voice, activating by voice, activating by touch, activating by signaling, mechanical movement, wireless uploading, wireless downloading, wireless transmitting, wireless signaling, etc.);
2) Video-only or e-book application, having all possible software functions.
   For example, some of the functions an application can have are: sounding, zooming, panning, captioning, fading, sliding, rotating, scrolling, converting voice to text, converting text to voice, activating by voice, activating by touch, activating by signaling, mechanical movement, wireless uploading, wireless downloading, wireless transmitting, wireless signaling, etc.);
3) Audio-only or e-book application, having all possible software functions.
   For example, some of the functions an application can have are: sounding, zooming, panning, captioning, fading, sliding, rotating, scrolling, converting voice to text, converting text to voice, activating by voice, activating by touch, activating by signaling, mechanical movement, wireless uploading, wireless downloading, wireless transmitting, wireless signaling, etc.);
4) Audio-and-text or e-book application, having all possible software functions.
   For example, some of the functions an application can have are: sounding, zooming, panning, captioning, fading, sliding, rotating, scrolling, converting voice to text, converting text to voice, activating by voice, activating by touch, activating by signaling, mechanical movement, wireless uploading, wireless downloading, wireless transmitting, wireless signaling, etc.);
5) Audio-only or e-book application, having all possible software functions.
   For example, some of the functions an application can have are: sounding, zooming, panning, captioning, fading, sliding, rotating, scrolling, converting voice to text, converting text to voice, activating by voice, activating by touch, activating by signaling, mechanical movement, wireless uploading, wireless downloading, wireless transmitting, wireless signaling, etc.); and
6) Text-only or e-book application, having all possible software functions.
   For example, some of the functions an application can have are: sounding, zooming, panning, captioning, fading, sliding, rotating, scrolling, converting voice to text, converting text to voice, activating by voice, activating by touch, activating by signaling, mechanical movement, wireless uploading, wireless downloading, wireless transmitting, wireless signaling, etc.).

### Second Example

Referring to FIGS. 1, 2, 3, 4, 5, 6, 7, and 8, the twenty formulas can be created as a mobile application and/or can be displayed on or via a mobile device. At any time and place (e.g., on a walk, in a park, on a beach, at a bus stop, in a meeting, etc.), with all the possible functions of software used on the mobile device (for example, some functions are: sounding, zooming, panning, captioning, fading, sliding, rotating, scrolling, converting voice to text, converting text to voice, activating by voice, activating by touch, activating by signaling, mechanical movement, wireless uploading, wireless downloading, wireless transmitting, wireless signaling, etc.), an inventor can perform at least one of the following tasks:
1) Learn the twenty formulas, on or via a mobile device;
2) Refer to the twenty formulas, on or via a mobile device;
3) Invent and record an invention, on or via a mobile device;
4) Describe an invention, on or via a mobile device;
5) Draw an invention, on or via a mobile device;
6) Store an invention, on or via a mobile device;
7) Transmit an invention, on or via a mobile device;
8) Share an invention, on or via a mobile device;
9) Email an invention, on or via a mobile device;
10) Fill out a patent form, on the website of the USPTO, on or via a mobile device;
11) File a patent application, on the website of the USPTO, on or via a mobile device; and
12) Pay a filling fee, on the website of the USPTO, on or via a mobile device.

### Third Example

Referring to FIGS. 6, 7, 8, 9, 10, and 11, the twenty formulas can be created as any mobile application in the first example above (e.g., a video-and-audio mobile application) and/or can be displayed on or via a mobile device (e.g., smart phone, tablet, etc.). At any time and place (e.g., on a walk, in a park, on a beach, at a bus stop, in a meeting, etc.), with all the possible functions of software used on the mobile device (for example, some functions are: sounding, zooming, panning, captioning, fading, sliding, rotating, scrolling, converting voice to text, converting text to voice, activating by voice, activating by touch, activating by signaling, mechanical movement, wireless uploading, wireless downloading, wireless transmitting, wireless signaling, etc.), an inventor can benefit from the unique system, by performing at least one of the tasks in the second example above.

The mobile application of the twenty formulas of the unique system describes a sample invention of footwear. Each of the formulas is used for describing only one aspect of the footwear, at the simplest descriptive level, as follows: (The indentation below is for ease of reading the example)

1) Title Formula describes only the title (at the simplest descriptive level):
FOOTWEAR FOR WALKING AND RUNNING

2) Figure Formula describes only the figures (at the simplest descriptive level):
FIGURE
Referring to FIGS. 1 and 2:
FIG. 1 illustrates a perspective view of the footwear.
FIG. 2 illustrates a side view of the footwear.

3) Component Formula describes only the components (at the simplest descriptive level):
COMPONENT
Referring to FIG. 1, the footwear comprises:
1) a sole 51,
2) a section 52,
3) a section 53,
4) a tongue 54,
5) a set of eyelets 55, and
6) a lace 56.

4) Material Formula describes only the materials (at the simplest descriptive level):
MATERIAL
Referring to FIG. 1:
1) Sole 51 is made of rubber.
2) Section 52 is made of leather.
3) Section 53 is made of leather.
4) Tongue 54 is made of fiber.
5) Eyelets 55 are made of aluminum.
6) Lace 56 is made of cotton.

5) Shape Formula describes only the shapes (at the simplest descriptive level):
SHAPE
Referring to FIG. 1:
1) Sole 51 has a bottle shape.
2) Section 52 has a convex shape.
3) Section 53 has a convex shape.
4) Tongue 54 has an oval shape.
5) Eyelets 55 each have a round shape.
6) Lace 56 has an elongated shape.

6) Connection Formula describes only the connections (at the simplest descriptive level):
CONNECTION
Referring to FIG. 1:
1) Sole 51 is glued to sections 52 and 53, at their edges.
2) Section 52 is sewn to section 53, at their fronts.
3) Section 53 is sewn to section 52, at their rears.
4) Tongue 54 is sewn to sections 52 and 53.
5) Eyelets 55 are riveted to sections 52 and 53.
6) Lace 56 is laced through eyelets 55.

7) Function Formula describes only the functions (at the simplest descriptive level):
FUNCTION
Referring to FIG. 1:
1) Sole 51 is for cushioning a foot.
2) Section 52 is for protecting the foot.
3) Section 53 is for protecting the foot.
4) Tongue 54 is for cushioning the foot.
5) Eyelets 55 are for attaching lace 56 to the footwear.
6) Lace 56 is for fastening the footwear on the foot.

8) Operation Formula describes only the operation (at the simplest descriptive level):
OPERATION
Referring to FIG. 2, the operation comprises the steps of:
1) Sliding the footwear on the foot,
2) Pulling lace 56 to a desired tension,
3) Tying the two ends of lace 56, together, and
4) Wearing the footwear for walking and running

9) Advantage Formula describes only the advantages (at the simplest descriptive level):
ADVANTAGE
Referring to FIG. 2:
1) The footwear provides a walking and running device.
2) The footwear provides protection to the foot.
3) The footwear provides safety to the foot.
4) The footwear provides cushion to the foot.
5) The footwear provides comfort to the foot.
6) The footwear provides tolerance to the foot.

10) Variation Formula describes only the variations (at the simplest descriptive level):
VARIATION
Referring to FIG. 2:
1) The surface of sole 51 can be non-slip.
2) Section 52 can be foldable.
3) Section 53 can be foldable.
4) Tongue 54 can be elastic.
5) Eyelets 55 can be fixed or rotatable.
6) The cross-section of lace 56 can be oval or round.

Referring to FIGS. 1-11, at any time and place (e.g., on a walk, in a park, on a beach, at a bus stop, in a meeting, etc.), with all the possible functions of software used on the mobile device (for example, some functions are: sounding, zooming, panning, captioning, fading, sliding, rotating, scrolling, converting voice to text, converting text to voice, activating by voice, activating by touch, activating by signaling, mechanical movement, wireless uploading, wireless downloading, wireless transmitting, wireless signaling, etc.), the inventor can benefit from the unique system, by performing at least one of the following tasks:
1) Learn the twenty formulas, on or via a mobile device;
2) Refer to the twenty formulas, on or via a mobile device;
3) Invent and record an invention, on or via a mobile device;
4) Describe an invention, on or via a mobile device;
5) Draw an invention, on or via a mobile device;
6) Store an invention, on or via a mobile device;
7) Transmit an invention, on or via a mobile device;
8) Share an invention, on or via a mobile device;
9) Email an invention, on or via a mobile device;
10) Fill out a patent form, on the website of the USPTO, on or via a mobile device;
11) File a patent application, on the website of the USPTO, on or via a mobile device; and
12) Pay a filling fee, on the website of the USPTO, on or via a mobile device.

### Conclusion

As stated in the first, second, and third examples above, the twenty formulas of the unique system can be created as a mobile or stationary application and/or can be displayed on or via a mobile or stationary device. A mobile device can be a mobile phone, a cellular phone, a handheld computer, a handheld electronic device, a portable media player, a wireless device, a tablet computer, a laptop computer, or an equivalent. A stationary application can be a desktop computer or an equivalent.

### 40 Major Advantages of the Invention

As a result of all the 40 following important advantages, the unique system will advance the economy, significantly:

### Enhancing Inventors' Capability

1) The unique system provides people of almost any age with a substantially effective and efficient method to quickly, easily, and clearly describe, understand, and invent inventions substantially better, by breaking the description of an invention into twenty simple formulas. Each of the simple formulas is for describing only one aspect of the invention (at the simplest descriptive level). This allows people of almost any age to quickly, easily, and clearly understand all the aspects of the invention (individually and collectively).
2) The unique system allows people of almost any age to quickly, easily, and clearly describe, specify, and broaden the scope of their inventions substantially better, by using the twenty simple formulas to create twenty simple sections. Each of the twenty simple sections is for describing only one aspect of the invention (at the simplest descriptive level). The twenty simple sections are, as follows: title, figure, reference, component, material, shape, dimension, smell, taste, feel, sound, connection, function, operation, purpose, advantage, variation, ramification, how to draw an invention, and how to file an invention.
3) The unique system allows people of almost any age to enhance their inventive capability substantially, by allowing them to quickly, easily, and clearly describe, understand, and invent all the aspects of all the components of an invention (at the simplest descriptive level).
4) The unique system allows people of almost any age to enhance their inventive capability substantially, by allowing them to be able to compare new unobvious advantages their inventions provide to old obvious disadvantages prior-art inventions provide (at the simplest descriptive level).

### Elevating their Inventions' Patentability

5) The unique system allows people of almost any age to elevate the patentability of their inventions, by allowing them to quickly, easily, and clearly understanding how many necessary components an invention needs to comprise to be complete and functional (at the simplest descriptive level).
6) The unique system allows people of almost any age to elevate the patentability of their inventions, by allowing them to quickly, easily, and clearly understanding what material each component of an invention is made of (at the simplest descriptive level).
7) The unique system allows people of almost any age to elevate the patentability of their inventions, by allowing them to quickly, easily, and clearly understanding what shape each component of an invention has (at the simplest descriptive level).
8) The unique system allows people of almost any age to elevate the patentability of their inventions, by allowing them to quickly, easily, and clearly understanding what dimension, smell, taste, and feel each component of an invention has (at the simplest descriptive level).
9) The unique system allows people of almost any age to elevate the patentability of their inventions, by allowing them to quickly, easily, and clearly understanding what sound each component of an invention makes (at the simplest descriptive level).
10) The unique system allows people of almost any age to elevate the patentability of their inventions, by allowing them to quickly, easily, and clearly understanding how each component of an invention is connected to other components (at the simplest descriptive level).
11) The unique system allows people of almost any age to elevate the patentability of their inventions, by allowing them to quickly, easily, and clearly understanding how each component of an invention functions (at the simplest descriptive level).
12) The unique system allows people of almost any age to elevate the patentability of their inventions, by allowing them to quickly, easily, and clearly understanding how an invention operates, what purposes the invention serves, what advantages the invention provides, what variations the invention has, and what ramifications the invention has (at the simplest descriptive level).

### Preserving Inventors' Rights, Eliminating Financial Obstacles, and Saving them a Lot of Money

13) The unique system allows people of almost any age to quickly and easily learn the twenty simple formulas, to preserve their rights to potential patents with ‘patent pending’ status for their inventions, on their own. Each of the twenty simple formulas is for describing only one aspect of the invention (at the simplest descriptive level). For example, an inventor can learn how to use the twenty simple formulas, within an hour.
14) The unique system provides people of almost any age with the capability to describe as many inventions as they want and to preserve their rights to potential patents with ‘patent pending’ status for their inventions, on their own. This eliminates the high cost of patent legal services.
15) The unique system eliminates the devastating problem of invention theft, by providing people of almost any age with the capability to describe their inventions and to preserve their rights to potential patents with ‘patent pending’ status, on their own, in total confidentiality. For example, inventors don't have to disclose their valuable inventions to total strangers for help with describing their inventions.
16) The unique system eliminates the financial roadblock created by the high cost of patent legal services, and saves significant amounts of money for people (Inventors don't have to blindly waste money on patent legal services for inventions before they are proven in the marketplace), by providing people of almost any age with the capability to describe as many inventions as they want and to preserve their rights to potential patents with ‘patent pending’ status for their inventions, on their own.
17) The unique system eliminates the financial roadblock created by the high cost of invention-drawing services, and saves significant amounts of money for people (Inventors don't have to blindly waste money on invention-drawing services for inventions before they are proven in the marketplace), by providing people of almost any age with the capability to hand-draw and/or computer-draw as many inventions as they want, on their own.

### Maximizing the Inventive Capability of Brilliant Inventors

18) The unique system allows people to utilize their brilliant minds to their maximum capability, by eliminating the financial obstacle of the high cost of patent legal services. For example, because inventors don't need any money to pay for patent legal services, they can freely invent to come up with as many brilliant inventions as possible, and can preserve their rights to potential patents with ‘patent pending’ status, on their own.
19) The unique system allows all brilliant minds to:
   Freely invent as many brilliant inventions as they want, and
   Freely preserve their rights to potential patents with ‘patent pending’ status for as many brilliant inventions as they want.
20) The unique system allows each inventor to present, not one, but multiple ‘patent pending’ inventions, at the same time, to prospective companies. This will increase each inventor's success rate of selling and/or licensing his inventions to the prospective companies;
21) The unique system allows prospective companies to have, not one, but multiple ‘patent pending’ inventions to choose from, at the same time, from each inventor. This will increase the prospective companies' success rate of profiting from each inventor's inventions.

### Filtering Out Unwanted Inventions, and Increasing the Number of Wanted Inventions, Substantially

22) The unique system allows prospective companies to:
   Filter out all unwanted inventions presented by inventors because the prospective companies have direct contact with consumers so they know what consumers don't want,
   Sign contracts with inventors to buy the legal rights of only wanted inventions or to be licensed to produce and sell only wanted inventions presented by inventors because the prospective companies have direct contact with consumers so they know what consumers want,
   Save significant amounts of time and money from their own research and development, and
   On behalf of inventors, hire patent law firms to file non-provisional patent applications for only the wanted inventions with the USPTO.
23) The unique system allows inventors to present, not one, but multiple ‘patent pending’ inventions, at the same time, to prospective companies. This allows the inventors to:
   Know which inventions are unwanted to avoid investing their inventive capability in them,
   Know which inventions are wanted to invest their inventive capability in them and, thus, save significant amounts of time and money from their own research and development,
   Focus their inventive capability on inventing only wanted inventions, and thus
   Increase the number of wanted inventions they will come up with, substantially.

### Preventing Unwanted Inventions from being Filed with the Patent and Trademark Office

24) The unique system eliminates and prevents all unwanted inventions from being filed with the USPTO because after all the unwanted inventions are filtered out, neither inventors nor prospective companies want to waste money for patent law firms to file non-provisional patent applications for the unwanted inventions with the USPTO. This eliminates all unnecessary workloads on the USPTO, and solves the long-felt problem of the USPTO having been overwhelmed with so many patent applications for unwanted inventions, which have wasted precious intellectual resources from inventors, companies, the USPTO, and, thus, the economy.

### Increasing Inventors' Revenues, Substantially, and Increasing Companies' Revenues, Substantially

25) The unique system allows inventors to avoid wasting their intellectual resources and their hard-earned money on unwanted inventions and the high cost of patent legal services.
26) The unique system, substantially, increases the number of brilliant inventions (invented by inventors and sold or licensed to companies to produce and sell to consumers, to advance the economy). Therefore, the unique system increases the number of contracts signed between inventors and companies, and, thus, inventors' and companies' revenues, substantially.
27) The unique system, substantially, increases the number of products (embodying brilliant inventions from inventors, produced by companies, and sold to consumers, to advance the economy). As a result of all the above 27 important advantages, the unique system will advance the economy.

### Increasing Patent Law Firms' Revenues, Substantially

28) The unique system increases patent law firms' revenues, substantially, by increasing the number of non-provisional patent applications (for only wanted inventions) to be filed with the USPTO, substantially, as follows:
   a) Each inventor unguidedly comes up with multiple unwanted inventions:
      Without the unique system, each inventor comes up with multiple inventions, and only has enough financial resource to hire a patent law firm to file a none-provisional patent application for one of his inventions. If this invention he presents to prospective companies is an unwanted invention (most of inventions are unwanted inventions because inventors don't have direct contact with consumers like prospective companies do so they don't know what consumers want), prospective companies will not want to invest in and lose money from it. The inventor doesn't want to waste any more of his hard-earned money and years of his life waiting, and thus, decides not to invent any more. As a result, the patent law firm gets only one order of filing a non-provisional patent application from the inventor.
   b) Each inventor guidedly comes up with multiple wanted inventions:
      With the unique system, each inventor can eliminate the high cost of patent law firm. Therefore, each inventor can freely invent to come up with multiple inventions and file provisional patent applications to get ‘patent pending’ status to preserve his rights to potential patents for all his inventions, on his own. Among each inventor's inventions presented, prospective companies will be able to pick out a wanted invention to invest in and profit from. The prospective companies will want each inventor to keep coming up with wanted inventions so they can save money on their own research and development. Knowing what wanted inventions are, each inventor starts focusing his inventive capability on coming up with only wanted inventions. Therefore, the number of wanted inventions each inventor will come up with will increase substantially, and each inventor will be able to sell and/or license, not one, but multiple wanted inventions to prospective companies. As a result, the patent law firm will keep getting, not one, but multiple orders of filing non-provisional patent applications from each inventor and/or prospective companies.
   Therefore, the unique system increases patent law firms' revenues, substantially,

### Learning and Referring to the Twenty Formulas, Quickly and Easily (Via Mobile Devices)

29) The unique system increases the convenience of mobile devices (e.g., smart phone, tablet, etc.) and eliminates the need for expensive cumbersome stationary devices (e.g., desktop computer, etc.) because the twenty formulas is invented to be large enough to be functionally legible within the dimension of the screen of mobile devices. This eliminates the inconvenient needs for people to enlarge and move the content of a file around, within the screen. Therefore, people of almost any age can learn and refer to the twenty formulas, quickly and easily, via mobile devices.
30) The unique system increases the practicality of mobile devices (e.g., smart phone, tablet, etc.) and eliminates the need for expensive cumbersome stationary devices (e.g., desktop computer, etc.) because the twenty formulas is invented to be large enough to be functionally legible within the dimension of the screen of mobile devices. This eliminates the inconvenient needs for people to enlarge and move the content of a file around, within the screen. Therefore, people of almost any age can learn and refer to the twenty formulas, quickly and easily, via mobile devices.
31) The unique system increases the usability of mobile devices (e.g., smart phone, tablet, etc.) and eliminates the need for expensive cumbersome stationary devices (e.g., desktop computer, etc.) because the twenty formulas is invented to be large enough to be functionally legible within the dimension of the screen of mobile devices. This eliminates the inconvenient needs for people to enlarge and move the content of a file around, within the screen. Therefore, people of almost any age can learn and refer to the twenty formulas, quickly and easily, via mobile devices.
32) The unique system increases the value of mobile devices (e.g., smart phone, tablet, etc.) and eliminates the need for expensive cumbersome stationary devices (e.g., desktop computer, etc.) because the twenty formulas is invented to be large enough to be functionally legible within the dimension of the screen of mobile devices. This eliminates the inconvenient needs for people to enlarge and move the content of a file around, within the screen. Therefore, people of almost any age can learn and refer to the twenty formulas, quickly and easily, via mobile devices.

### Learning and Referring to the Twenty Formulas (Via Mobile Devices, at any Time and Place), and Inventing and Describing Inventions (Via Mobile Devices, at any Time and Place)

33) The unique system allows people to learn and refer to the twenty formulas quickly and easily at any time and place (e.g., on a walk, in a park, on a beach, at a bus stop, in a meeting, etc.) via mobile devices (e.g., smart phone, tablet, etc.) because the twenty formulas is invented to be large enough to be functionally legible within the dimension of the screen of mobile devices. This eliminates the inconvenient needs for people to enlarge and move the content of a file around within the screen, constantly. Therefore, people of almost any age can learn and refer to the twenty formulas, quickly and easily, via mobile devices. This eliminates the need for expensive cumbersome stationary devices (e.g., desktop computer, etc.).
34) The unique system allows people to invent and record inventions, conveniently, at any time and place (e.g., on a walk, in a park, on a beach, at a bus stop, in a meeting, etc.) via mobile devices (e.g., smart phone, tablet, etc.) because the twenty formulas is invented to be large enough to be functionally legible within the dimension of the screen of mobile devices. This eliminates the inconvenient needs for people to enlarge and move the content of a file around within the screen, constantly. Therefore, people of almost any age can learn and refer to the twenty formulas, quickly and easily, via mobile devices. This eliminates the need for expensive cumbersome stationary devices (e.g., desktop computer, etc.).
35) The unique system allows people to describe inventions by using voice-to-text function, at any time and place (e.g., on a walk, in a park, on a beach, at a bus stop, in a meeting, etc.) via mobile devices (e.g., smart phone, tablet, etc.) because the twenty formulas is invented to be large enough to be functionally legible within the dimension of the screen of mobile devices. This eliminates the inconvenient needs for people to enlarge and move the content of a file around within the screen, constantly. Therefore, people of almost any age can learn and refer to the twenty formulas, quickly and easily, via mobile devices. This eliminates the need for expensive cumbersome stationary devices (e.g., desktop computer, etc.).

### Transmitting Inventions Between Mobile Devices, Stationary Devices, and the Internet

36) The unique system increases the convenience, practicality, usability, value of software used on mobile devices (e.g., smart phone, tablet, etc.), with the synergism of the twenty formulas, software, and mobile devices.
37) The unique system allows people to:
   Learn the twenty formulas
   (by using converting-voice-to-text function, converting-text-to-voice function, voice command, touch command, signal command, mechanical command, etc.), at any time and place, via software used on mobile devices
   (e.g., smart phone, tablet, etc.);
   Refer to the twenty formulas
   (by using converting-voice-to-text function, converting-text-to-voice function, voice command, touch command, signal command, mechanical command, etc.), at any time and place, via software used on mobile devices
   (e.g., smart phone, tablet, etc.);
   Invent and record inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Describe their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Draw their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Store their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Transmit their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Share their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Email their inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   Fill out patent applications for inventions,
   (by using converting-voice-to-text function, converting-text-to-voice function, voice command, touch command, signal command, mechanical command, etc.), at any time and place, via software used on mobile devices
   (e.g., smart phone, tablet, etc.);
   File patent applications for inventions,
   (by using converting-voice-to-text function, converting-text-to-voice function, voice command, touch command, signal command, mechanical command, etc.), at any time and place, via software used on mobile devices
   (e.g., smart phone, tablet, etc.); and
   Pay filing fees for patent applications,
   (by using converting-voice-to-text function, converting-text-to-voice function, voice command, touch command, signal command, mechanical command, etc.), at any time and place, via software used on mobile devices
   (e.g., smart phone, tablet, etc.).
38) The unique system allows people to use all the possible functions of software used on mobile devices (for example, some functions are: converting voice to text, converting text to voice, activating by voice, activating by touch, wireless uploading, wireless downloading, wireless transmitting, etc.), to eliminate the needs for using cumbersome pen and paper, to:
   Learn the twenty formulas, at any time and place
   (e.g., on a walk, in a park, on a beach, at a bus stop, in a meeting, etc.);
   Invent and record their inventions, at any time and place
   (e.g., on a walk, in a park, on a beach, at a bus stop, in a meeting, etc.);
   Describe their inventions, at any time and place
   (e.g., on a walk, in a park, on a beach, at a bus stop, in a meeting, etc.); and
   Draw their inventions, at any time and place
   (e.g., on a walk, in a park, on a beach, at a bus stop, in a meeting, etc.).
39) The unique system allows people to conveniently transmit their inventions electronically:
   From mobile devices to mobile devices (e.g., smart phone, tablet, etc.)
   to share (for example, in a meeting, at a conference, etc.), at any time and place;
   From mobile devices to stationary devices (e.g., desktop computer, etc.)
   to store (for example, on Sugarsync for future use, etc.), at any time and place;
   From mobile devices to the internet (e.g., website of the USPTO, email account, etc.)
   to file provisional or non-provisional patent applications, at any time and place; and
   From stationary devices to the internet (e.g., website of the USPTO, etc.)
   to file provisional or non-provisional patent applications, at any time and place.

### Best Maximizing the Capability of Precious Intellectual Resources, Nationwide and Globally

40) The unique system allows people and/or prospective companies to, quickly and easily:
   Free themselves to invent as many inventions as they want, by eliminate the financial obstacle of the high cost of patent legal services, which has stifled their inventive capability.
   File provisional patent applications to preserve their rights with ‘patent pending’ status for all their inventions, on their own, in total confidentiality,
   Filter out all unwanted inventions,
   Focus on inventing only wanted inventions,
   Save significant amounts of time and money from their own research and development,
   Increase the number of wanted inventions invented, substantially,
   Increase the number of contracts signed between them, substantially,
   Increase the revenues of inventor and prospective companies, substantially,
   Place multiple orders with patent law firms to file non-provisional patent applications for only their wanted inventions. This increases the revenues of patent law firms, substantially,
   Describe their inventions, via mobile devices, at any place and time,
   Share their inventions, via mobile devices, at any place and time,
   Store their inventions, via mobile devices, at any place and time,
   File patent applications for inventions, via mobile devices, at any place and time, and
   Eliminate and prevent all unwanted inventions from being filed with the USPTO. This eliminates all unnecessary workloads on the USPTO, and solves the long-felt problems of the USPTO having been overwhelmed with so many patent applications for unwanted inventions, which have wasted precious intellectual resources from inventors, companies, patent law firms, the USPTO, and, thus, the economy.
   Therefore, the unique system best maximizes the capability of precious intellectual resources from inventors, companies, patent law firms, the USPTO, and, thus, the economy.

As a result of all the above forty important advantages, the unique system will advance the economy, significantly.

What is claimed is:

1. A system for describing an invention, the system comprising:
at least one device, said at least one device having a monitor, a processor, and a memory;
at least one invention-describing formula,
said at least one invention-describing formula stored in said memory,
said at least one invention-describing formula for describing said invention; and
at least one software,
said at least one software stored in said memory,
said processor coupled to said memory for executing said at least one software,
said processor for processing input from a user,
said processor for displaying said invention and said at least one invention-describing formula on said monitor.

2. The system of claim 1, wherein said invention comprises at least one component,
said invention has a title,
each of said at least one component has a name and a reference number,
each of said at least one component is made of at least one material,
each of said at least one component has at least one shape,
each of said at least one component has at least one dimension,
each of said at least one component has at least one smell,
each of said at least one component has at least one taste,
each of said at least one component has at least one feel,
each of said at least one component has at least one sound,
each of said at least one component has at least one connection,
each of said at least one component has at least one function,
said invention has at least one operation,
said invention has at least one purpose,
said invention has at least one advantage,
said invention has at least one variation,
said invention has at least one ramification,
each of said at least one component has at least one variation, and
each of said at least one component has at least one ramification,
wherein each of said at least one invention-describing formula is selected from the group consisting of:
describing said title of said invention,
describing said name and reference number of each of said at least one component,
describing what each of said at least one component is,
describing said at least one material of each of said at least one component,
describing said at least one shape of each of said at least one component,
describing said at least one dimension of each of said at least one component,
describing said at least one smell of each of said at least one component,
describing said at least one taste of each of said at least one component,
describing said at least one feel of each of said at least one component,
describing said at least one sound of each of said at least one component,
describing said at least one connection of each of said at least one component,
describing said at least one function of each of said at least one component,
describing said at least one operation of said invention,
describing said at least one purpose of said invention,
describing said at least one advantage of said invention,
describing said at least one variation of said invention,
describing said at least one ramification of said invention,
describing said at least one variation of each of said at least one component, and
describing said at least one ramification of each of said at least one component.

3. The system of claim 1, wherein each of said at least one invention-describing formula is selected from the group consisting of:
The invention for what purpose(s)?,
Each figure illustrates what view(s)?,
Component name and Reference number?,
The invention comprises what component(s)?,
Each component is made of what material(s)?,
Each component has what shape(s)?,
Each component has what dimension(s)?,
Each component has what smell(s)?,
Each component has what taste(s)?,
Each component has what feel(s) to it?,
Each component makes what sound(s)?,
Each component is connected to other(s) (how?),
Each component is for what function(s)?,
The operation comprises what step(s) or action(s)?,
The invention is for what purpose(s)?,
The invention provides what advantage(s)?,
The invention has what variation(s)?,
The invention has what ramification(s)?,
Each component has what variation(s)?, and
Each component has what ramification(s)?.

4. The system of claim 1, further comprising an application, an application fee, and at least one formula selected from the group consisting of:
recording said invention,
describing said invention,
drawing said invention,
displaying said invention,
storing said invention,
transmitting said invention,
sharing said invention,
emailing said invention,
filling out said application for said invention,
filing said application for said invention,
paying said application fee for said invention, and
a combination of at least two of the above.

5. The system of claim 1, further comprising
a formula for drawing at least one figure of said invention and
a formula for describing said at least one figure of said invention.

6. The system of claim 1, further comprising an application, an application fee,
a formula for filling out said application for said invention,
a formula for filing said application for said invention, and
a formula for paying said application fee for said invention.

7. The system of claim 1, wherein each of said at least one device is selected from the group consisting of:
a mobile phone, a cellular phone, a handheld computer, a handheld electronic device, a portable media player, a wireless device, a tablet computer, a laptop computer, and a combination of at least two of the above.

8. The system of claim 1, wherein said at least one device is a desktop computer.

9. A method for describing an invention, provided said invention,
said invention comprising at least one component,
said invention having a title,
each of said at least one component having a name and a reference number,
each of said at least one component being made of at least one material,
each of said at least one component having at least one shape,
each of said at least one component having at least one dimension,
each of said at least one component having at least one smell,
each of said at least one component having at least one taste,
each of said at least one component having at least one feel,
each of said at least one component having at least one sound,
each of said at least one component having at least one connection,
each of said at least one component having at least one function,
said invention having at least one operation,
said invention having at least one purpose,
said invention having at least one advantage,
said invention having at least one variation,
said invention having at least one ramification,
each of said at least one component having at least one variation, and
each of said at least one component having at least one ramification,
the method comprising at least one step selected from the group consisting of:
describing said title of said invention,
describing said name and reference number of each of said at least one component,
describing what each of said at least one component is,
describing said at least one material of each of said at least one component,
describing said at least one shape of each of said at least one component,
describing said at least one dimension of each of said at least one component,
describing said at least one smell of each of said at least one component,
describing said at least one taste of each of said at least one component,
describing said at least one feel of each of said at least one component,
describing said at least one sound of each of said at least one component,
describing said at least one connection of each of said at least one component,
describing said at least one function of each of said at least one component,
describing said at least one operation of said invention,
describing said at least one purpose of said invention,
describing said at least one advantage of said invention,
describing said at least one variation of said invention,
describing said at least one ramification of said invention,
describing said at least one variation of each of said at least one component, and
describing said at least one ramification of each of said at least one component.

10. The method of claim 9, further comprising the steps of:
drawing at least one figure of said invention; and
describing said at least one figure of said invention.

11. The method of claim 10, provided at least one application form and at least one application fee, the method further comprising the steps of:
filling out said at least one application form for said invention;
filing said at least one application form for said invention; and
paying said at least one application fee for said invention.

12. The method of claim 9, further comprising the step of filing said invention.

13. The method of claim 9, wherein each of said at least one device is selected from the group consisting of:
a mobile phone, a cellular phone, a handheld computer, a handheld electronic device, a portable media player, a mobile device, a wireless device, a tablet computer, a laptop computer, a desktop computer, and a combination of at least two of the above.

14. The method of claim 13, further comprising a step selected from the group consisting of:
displaying said invention and said at least one invention-describing formula on said at least one device,
displaying said invention on said at least one device, and
displaying said at least one invention-describing formula on said at least one device.

15. A method for describing an invention, provided a system and said invention,
said system comprising at least one device, at least one software, and at least one invention-describing formula for describing said invention,
said at least one device having a monitor, a processor, and a memory,
said at least one invention-describing formula stored in said memory,
said at least one software stored in said memory,
said processor coupled to said memory for executing said at least one software,
said processor for processing input from a user,
said processor for displaying said invention and said at least one invention-describing formula on said monitor,
said invention comprising at least one component,
said invention having a title,
each of said at least one component having a name and a reference number,
each of said at least one component being made of at least one material,
each of said at least one component having at least one shape,
each of said at least one component having at least one dimension,
each of said at least one component having at least one smell,
each of said at least one component having at least one taste,
each of said at least one component having at least one feel,
each of said at least one component having at least one sound,
each of said at least one component having at least one connection,
each of said at least one component having at least one function,
said invention having at least one operation,
said invention having at least one purpose,
said invention having at least one advantage,
said invention having at least one variation,
said invention having at least one ramification,
each of said at least one component having at least one variation,
each of said at least one component having at least one ramification,
the method comprising at least one step selected from the group consisting of:
describing said title of said invention,
describing said name and reference number of each of said at least one component,
describing what each of said at least one component is,
describing said at least one material of each of said at least one component,
describing said at least one shape of each of said at least one component,
describing said at least one dimension of each of said at least one component,
describing said at least one smell of each of said at least one component,
describing said at least one taste of each of said at least one component,
describing said at least one feel of each of said at least one component,
describing said at least one sound of each of said at least one component,
describing said at least one connection of each of said at least one component,
describing said at least one function of each of said at least one component,
describing said at least one operation of said invention,
describing said at least one purpose of said invention,
describing said at least one advantage of said invention,
describing said at least one variation of said invention,
describing said at least one ramification of said invention,
describing said at least one variation of each of said at least one component, and
describing said at least one ramification of each of said at least one component.

16. The method of claim 15, further comprising the steps of:
drawing at least one figure of said invention; and
describing said at least one figure of said invention.

17. The method of claim 15, further comprising the step of filing said invention.

18. The method of claim 15, further comprising at least one step selected from the group consisting of:
recording said invention,
describing said invention,
drawing said invention,
displaying said invention,
storing said invention,
transmitting said invention,
sharing said invention,
emailing said invention,
filling out an application for said invention,
filing an application for said invention,
paying an application-filling fee for said invention, and
a combination of at least two of the above.

19. The method of claim 15, wherein each of said at least one device is selected from the group consisting of:
a mobile phone, a cellular phone, a handheld computer, a handheld electronic device, a portable media player, a mobile device, a wireless device, a tablet computer, a laptop computer, a desktop computer, and a combination of at least two of the above.

20. The method of claim 19, further comprising a step selected from the group consisting of:
displaying said invention and said at least one invention-describing formula on said at least one device,
displaying said invention on said at least one device, and
displaying said at least one invention-describing formula on said at least one device.
